(19) United States
(12) Patent Application Publication
(10) Pub. No.: US 2026/0241938 A1
(43) Pub. Date: Aug. 20, 2026

(54) METHOD FOR CLASSIFYING A DRIVING STATE OF A VEHICLE AS WELL AS VEHICLE

(71) Applicants: Bayerische Motoren Werke Aktiengesellschaft, München (DE); Robert Bosch GmbH, Stuttgart (DE)

(72) Inventors: Martin Flossmann, Waakirchen (DE); Karl Ludwig Stolle, Renningen (DE); Anja Wahl, Markgröningen (DE)

(21) Appl. No.: 19/543,485

(22) Filed: Feb. 18, 2026

(30) Foreign Application Priority Data
Feb. 20, 2025 (DE) 10 2025 106 344.3

(51) Int. Cl. B60W 50/00

(52) U.S. Cl. CPC B60W 50/00; B60W 2050/0016; B60W 2510/202; B60W 2520/105; B60W 2520/18

(57) ABSTRACT

A method for classifying a driving state of a vehicle, in which n torque value is determined by means of a computing device, which characterizes a current steering moment acting in a steering of the vehicle. An angle value is determined, which characterizes a current roll angle of the vehicle. A speed value is determined and forms a pair of values with associated angle value. One of the reference pairs of values is selected as the reference pair of values associated with the pair of values from a reference characteristic map, which includes reference angle values, reference speed values and reference torque values and associates exactly one of the reference torque values with a respective reference pair of values, which includes exactly one of the reference angle values and exactly one of the reference speed values. The reference torque value associated with the selected reference pair of values is determined.

### RELATED APPLICATIONS

This application claims the benefit under 35 USC 119(a) of German patent application 10 2025 106 344.3 filed on Feb. 20, 2025 in the Deutsches Patentund Markenamt, the entire disclosure of which is incorporated herein by reference for all purposes.

### FIELD

The following description relates to a method for classifying a driving state of a vehicle. In addition, the invention relates to a vehicle.

### BACKGROUND

US 2022/0126833 A1 discloses a method, in which road friction value information is received, which indicates road friction estimations for multiple areas, which surround a vehicle. From US 10 773 725 B1, a method is known, in which images, which show a roadway arranged in front of the vehicle, are determined using sensors of a vehicle. A method for estimating friction coefficients of a wheel of a vehicle in relation to a surface lying beneath can be taken as known from US 2018/0037234 A1. Furthermore, DE 10 2009 002 245 A1 discloses a method for determining the friction value between tires and roadway in a vehicle. EP 2 290 318 B1 discloses a tilting vehicle. In addition, a steering system for a vehicle is known from DE 10 2019 210 807 A1, with at least one sensor for determining the steering moment.

All documents cited in the present disclosure, including published documents, patent applications, and patents, may be incorporated herein in their entirety by reference in the same manner as when each cited document is separately and specifically incorporated or incorporated in its entirety.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspects, there is provided a method for classifying a driving state of a vehicle, in which by means of an electronic computing device: at least one actual torque value is determined, which characterizes a current steering moment acting in a steering of the vehicle; at least one actual angle value is determined, which characterizes a current roll angle of the vehicle; at least one actual speed value is determined, which characterizes a current driving speed of the vehicle and forms an actual pair of values with the associated actual angle value; depending on the actual pair of values, one of the reference pairs of values is selected as the pair of values associated with the actual pair of values from a reference characteristic map, which includes multiple reference angle values, multiple reference speed values and multiple reference torque values and associates exactly one of the reference torque values with a respective reference pair of values, which includes exactly one of the reference angle values and exactly one of the reference speed values; the reference torque value associated with the selected reference pair of values is determined; he determined reference torque value is compared to the determined actual torque value, whereby a difference (dM) between the determined reference torque value and the determined actual torque value is determined; and for classifying the driving state, the driving state is associated with one of multiple preset classes (K12, K2, K3) depending on the difference (dM).

In another general aspect, there is provided a vehicle which is formed for performing a method a method for classifying a driving state of the vehicle, in which by means of an electronic computing device: at least one actual torque value is determined, which characterizes a current steering moment acting in a steering of the vehicle; at least one actual angle value is determined, which characterizes a current roll angle of the vehicle; at least one actual speed value is determined, which characterizes a current driving speed of the vehicle and forms an actual pair of values with the associated actual angle value; depending on the actual pair of values, one of the reference pairs of values is selected as the pair of values associated with the actual pair of values from a reference characteristic map, which includes multiple reference angle values, multiple reference speed values and multiple reference torque values and associates exactly one of the reference torque values with a respective reference pair of values, which includes exactly one of the reference angle values and exactly one of the reference speed values; the reference torque value associated with the selected reference pair of values is determined; he determined reference torque value is compared to the determined actual torque value, whereby a difference (dM) between the determined reference torque value and the determined actual torque value is determined; and for classifying the driving state, the driving state is associated with one of multiple preset classes (K12, K2, K3) depending on the difference (dM).

It is the object of the present invention to provide a method and a vehicle such that a driving state of the vehicle can be particularly advantageously classified and thus determined.

According to the invention, this object is solved by a method with the features of claim 1 as well as by a vehicle with the features of claim 15. Advantageous configurations of the invention are the subject matter of the dependent claims.

Other features and aspects will be apparent from the following detailed description, the drawings, and the claims.

### BRIEF DESCRIPTION OF THE DRAWINGS

Further details of the invention are apparent from the following drawings.

FIG. 1 illustrates an example of a schematic side view of a vehicle formed as a single-track two-wheeled vehicle.

FIG. 2 illustrates an example of a flow diagram for illustrating a method for classifying an in particular current driving state of the vehicle.

FIG. 3 illustrates an example of a further flow diagram for further illustrating the method.

FIG. 4 illustrates an example of a further flow diagram for further illustrating the method.

FIG. 5 illustrates an example of a schematic representation of a state machine for advantageously classifying the driving state.

Throughout the drawings and the detailed description, unless otherwise described or provided, the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

A first aspect of the invention relates to a method for classifying a, in particular current, driving state of a vehicle preferably formed as a motor vehicle, in particular during a drive of the vehicle. This for example means that the method is performed during the drive of the vehicle, which is for example driven, in particular forward, along a terrain during the drive. For example, the terrain is or forms a ground such that the motor vehicle is for example driven along the ground. In particular, the ground for example forms a roadway. In particular, the vehicle is downwardly supported on the ground in vehicle vertical direction while the vehicle drives along the ground, that is along the terrain. For example, the vehicle comprises at least one vehicle wheel also simply referred to as wheel, via which the vehicle is downwardly supported on the terrain in vehicle vertical direction of the vehicle in particular in driving and thus in the method, such that the vehicle wheel, in particular directly, contacts the terrain, that is, in particular indirectly, rests on the ground. Thus, the vehicle wheel is a ground contact element of the vehicle, which is downwardly supported in vehicle vertical direction of the vehicle via the ground contact element in particular during the drive and thus during the method. In particular, the vehicle wheel for example includes a rim and a tire in particular formed separately from the rim, which is fitted onto the rim and thus is carried by the rim and for example formed of rubber. If the vehicle is driven along the terrain in driving and thus preferably in the method, while the vehicle is downwardly supported on the ground in vehicle vertical direction of the vehicle via the ground contact element, thus, the ground contact element, in particular directly, rolls on the ground, that is on the terrain, such that in particular the tire, in particular directly, rolls on the terrain. In particular, the vehicle wheel is rotatably retained on a component about a wheel rotational axis in relation to the component of the vehicle, wherein it is in particular provided that the vehicle wheel, in particular directly, rolls on the terrain and therein rotates about the wheel rotational axis in relation to the component during the method or during the drive. In particular, the component is a steering element, for example formed as a fork, in particular front fork, of a steering of the vehicle, in particular if the vehicle is for example formed as a single-track two-wheeled vehicle. Therein, the steering element is for example pivotably retained on a chassis about a pivot axis also referred to as steering axis in relation to the chassis of the vehicle for example formed as a frame, in particular lattice tube frame. Therein, the vehicle wheel for example formed as a front wheel is pivotable with the steering element about the steering axis in relation to the chassis. By pivoting the steering element and thus the vehicle wheel effected about the steering axis and in relation to the chassis, the vehicle can be steered, hence cornering maneuvers, driving direction changes and roadway or lane changes of the vehicle can be caused thereby. For example, a person, in particular currently, using the vehicle, such as for example a rider of the vehicle, can pivot the steering element and the vehicle wheel with it about the steering axis in relation to the chassis to steer the vehicle, hence to thereby effect cornering maneuvers, driving direction changes and lane or roadway changes of the motor vehicle. Hereto, the person in particular currently using the vehicle can for example grip, in particular encompass, a steering handle of the steering and thus of the vehicle with their hands, such that the person can exert a force or a torque on the steering handle and thus the steering, hence introduce it into the steering handle and thus into the steering, via their arms, which include the hands of the person. A torque also referred to as person moment or person torque, effected by the person and exerted on the steering, results from it, which in particular acts about the steering axis.

In the method, at least one actual torque value is determined by means of an electronic computing device, in particular of the vehicle, which characterizes, that is indicates describes or defines, a current steering moment acting in the steering of the vehicle and also referred to as steering torque. In particular, the steering moment is for example a torque acting about the steering axis, which for example acts in the steering in that the person exerts, as previously described, the person moment on the steering, in particular on the steering element and via the steering element on the steering, such that the steering moment for example is the person moment or results from the person moment. In particular, the steering moment can be composed at least of the person moment and of an additional torque different from the person moment, which is also referred to as steering moment portion or portion of steering moment. For example, the steering moment acting in the steering is captured by means of a measurement device, in particular of the vehicle. Therein, the measurement device for example provides an in particular electrical measurement device signal, wherein the electronic computing device for example receives the measurement device signal. The measurement device signal characterizes the steering moment captured by means of the measurement device such that the measurement device signal for example includes the actual torque value. In that the electronic computing device receives the measurement device signal, the electronic computing device for example determines the actual torque value. Further, it is conceivable that the electronic computing device receives the measurement device signal and determines, in particular calculates, the actual torque value depending on the received measurement device signal.

In the method, at least one actual angle value is determined by means of the electronic computing device, which characterizes a current roll angle of the vehicle. A movement of the vehicle about the vehicle longitudinal direction thereof also referred to as longitudinal axis or vehicle longitudinal axis is to be understood by rolling, which in particular extends along an imagined straight line and for example extends through the center of mass of the vehicle also referred to as center of gravity. Therein, the roll angle is an angle, about which the vehicle, in particular currently, rolls in particular related to an initial position also referred to as neutral position, hence is inclined about the longitudinal axis. Basically, it is conceivable that the current roll angle and thus for example the actual angle value are zero such that the vehicle is in the mentioned initial position, hence is not inclined in vehicle transverse direction with respect to the initial position, or else the current roll angle is a non-zero angle, by which the vehicle is currently inclined about the longitudinal axis in particular with respect to the neutral position such that the vehicle is for example currently in an inclination position different from the neutral position viewed about the longitudinal axis and such that the actual angle value for example is a non-zero value. For example, the current roll angle is calculated by means of the electronic computing device. Further, it is conceivable that the current roll angle is captured by means of the measurement device of the vehicle, wherein the actual angle value characterizes the current roll angle captured by means of the measurement device.

In the method, at least one actual speed value is determined by means of the electronic computing device, which is also referred to as control device, which characterizes a current driving speed simply also referred to as speed of the vehicle, which for example drives, in particular forward, with the driving speed in particular in the previously mentioned drive and thus in the method, In particular, the current driving speed of the vehicle and thus the actual speed value are non-zero and in particular greater than zero, such that the vehicle for example drives or is driven, in particular forward, with the driving speed along the terrain during the method, that is in the method. For example, the current driving speed of the vehicle is measured, that is captured, by means of the measurement device of the vehicle, such that the actual speed value for example characterizes, that is indicates, describes or defines, the current, measured driving speed. The determined actual angle value is associated with the determined actual speed value and vice versa, such that the determined actual angle value and the determined actual speed value form an actual pair of values. Hereby, it is not necessarily to be understood that the electronic computing device forms the mentioned actual pair of values from the actual angle value and the actual speed value, hence the electronic computing device does not necessarily perform a special computing step to form the actual pair of values from the actual angle value and the actual speed value or to associate the actual angle value and the actual speed value with the actual pair of values or the like, but the determined actual angle value and the determined actual speed value are basically regarded as values forming the mentioned actual pair of values. This is in particular the case to be able to illustratively and comprehensibly describe the method below based on the term “actual pair of values”.

In the method, by means of the electronic computing device, depending on the actual pair of values, that is depending on the actual angle value and depending on the actual speed value, one of the reference pairs of values is selected and thus in particular retrieved as the pair of values associated with the actual pair of values from, in particular exactly, one reference characteristic map, which includes multiple reference angle values, multiple reference speed values and multiple reference torque values, and associates exactly one of the reference torque values with a respective reference pair of values, which includes exactly one of the reference angle values and exactly one of the reference speed values. For example, the reference characteristic map is a steering moment characteristic map also referred to as reference steering moment characteristic map. Further, the characteristic map is for example a characteristic map determined for a reference friction value, which will be explained in more detail in the following. For example, the reference friction value is a, in particular high, friction value, which for example exceeds a limit value.

In particular, the reference characteristic map is an at least or exactly three-dimensional characteristic map, which quasi indicates, that is describes, the reference torque values across the reference angle values and across the reference speed values. Therein, it is conceivable that multiple of the reference pairs of values are associated with the respective reference torque value. It is further conceivable that the same reference angle value is a part of multiple of the reference pairs of values. Further, it is conceivable that the same reference speed value is a part of multiple of the reference pairs of values. By the feature that the respective reference pair of values includes exactly one of the reference angle values and exactly one of the reference speed values and by the feature that, in particular exactly, one of the reference pairs of values is selected as the pair of values associated with the actual pair of values, it does not necessarily have to be understood that the reference pairs of values, hence the reference angle values and the reference speed values, as the reference pairs of values are actually stored and contained in the reference characteristic map, but the term “reference pair of values” is first only used to be able to illustratively and comprehensibly describe the method in the following. Thus, in particular by the feature that depending on the actual pair of values, hence depending on the actual speed value and depending on the actual angle value, in particular exactly, one of the reference pairs of values is selected, it is to be understood that depending on the actual pair of values, hence depending on the actual speed value and depending on the actual angle value, in particular exactly, one of the reference angle values and, in particular exactly, one of the reference speed values is selected and thus retrieved from the characteristic map, wherein the selected reference angle value and the selected reference speed value are associated with the determined actual pair of values, hence with the determined actual angle value and with the determined actual speed value, and conceptually form the for example only imagined reference pair of values.

By means of the electronic computing device, the reference torque value associated with the selected reference pair of values is determined, in particular read out of the reference characteristic map, which is also simply referred to as characteristic map, in the method. This means that, in particular exactly, one of the reference torques is determined by means of the electronic computing device depending on the selected reference angle value and depending on the selected reference speed value.

By means of the electronic computing device, the determined reference torque value is compared to the actual torque value, whereby a difference also referred to as discrepancy between the determined reference torque value and the determined actual torque value is determined. This difference is also referred to as spacing of the actual torque value from the characteristic map, that is from the determined reference torque value. In other words, a comparison is performed by means of the electronic computing device, in which the determined reference torque value is compared to the determined actual torque value, whereby the mentioned difference between the determined reference torque value and the determined actual torque value is determined, in particular calculated, by the comparison.

For classifying the driving state, the driving state is associated with, in particular exactly, one of multiple preset classes depending on the difference by means of the electronic computing device, wherein the one class, with which the driving state is associated, to thereby classify the driving state, is also referred to as first class. For example, the classes are stored in a, in particular electronic and/or electrical, data memory, in particular of the electronic computing device. By the method according to the invention, the in particular current driving state of the vehicle can be particularly advantageously classified, whereby a basis for an advantageous operation of the vehicle can be realized. In particular, it can be provided in the method that at least one component of the vehicle is operated depending on the classification of the driving state. The operation of the component of the vehicle depending on the classification of the driving state for example includes that an indication signal for example optically and/or haptically and/or acoustically perceivable by the person currently using the vehicle is in particular output to an environment of the component, in particular by means of the component. The component is or includes for example an in particular electrical and/or electronic playback device, by means of which the indication signal is output to the environment of the playback device. By means of the indication signal, the one class, with which the driving state was or is associated, can for example be communicated to the person using the vehicle. Hereby, the person can be particularly advantageously informed about the current driving state of the vehicle. As a consequence, the person can for example adapt or change their driving behavior to hereby for example be able to safely drive the vehicle. The association of the driving state with the one class is also referred to as categorizing the driving state into the one class.

The one class, into which the driving state is categorized, is, characterizes or describes for example a safe driving state, hence a safe drive, such that it can for example be communicated to the person that the current driving state of the vehicle is a safe, hence stable driving state, in particular by outputting the indication signal.

In particular, it is possible that the driving state is selectively associated with the one class (first class) or a second one of the classes depending on the difference by means of the electronic computing device for classifying the driving state, to thereby classify the driving state. If the driving state is for example associated with the second class, hence categorized into the second class, and if the second class for example is, describes, characterizes or defines a drive of the motor vehicle effected close to a limit range of the vehicle, thus, the person can for example be informed, in particular by outputting the indication signal, that the person currently drives the vehicle close to the limit range of the vehicle. This can for example be due to the fact that an in particular current friction between the terrain and the vehicle wheel and thus a friction value characterizing the current friction between the vehicle wheel and the terrain are low, in particular lower than the previously mentioned high friction value (reference friction value). As a result, the person can for example change their driving behavior, in particular such that the current driving state of the vehicle changes such that the current driving state of the vehicle is no longer associated with the second class, but with the first class. Thereby, the person can transfer the current driving state of the vehicle from a drive close to the limit range towards a comparatively safer drive of the vehicle such that the person can safely drive the vehicle.

In particular, the following realizations and considerations underlie the invention: If the vehicle drives on the terrain and if an only low friction, hence only a low friction value characterizing the low friction, exists between the terrain and the vehicle wheel, thus, this can be qualitatively determined by the method. Hereto, the prerequisite for a particularly advantageous, in particular safe, drive of the vehicle is established.

First, the starting point of the invention was the assumption that in stationary circular travel with defined speed and inclination position, hence roll angles, different steering moments have to be adjusted or have to act on different friction values to follow the same defined circular path. Specifically, the steering moment has to be changed on reduced friction value towards inside of the curve compared to a drive on comparatively higher friction value. However, it was found that this effect is low with low inclination positions, hence at small roll angles, and increases with greater inclination positions. Specially, if the vehicle for example formed as a motorbike and thus as a single-track two-wheeled vehicle is on reduced friction value close to a limit inclination position for this friction value upon cornering and thereby exits the so-called linear tire range, wherein the limit inclination position is for example such an inclination position or such a roll angle of the vehicle that upon exceeding the limit inclination position by the current roll angle of the vehicle, the vehicle wheel and thus the vehicle slips, in particular slips away, in relation to the terrain, thus, the steering moment to be adjusted considerably differs from the steering moment to be adjusted on the comparatively higher friction value. Measurements of the steering moment have shown that a signal characterizing the measured steering moment can have a very poor usable signal-to-noise ratio, thus, such a measurement of the steering moment can be very inaccurate. Thus, the effect, that a different steering moment is to be adjusted on lower friction value than on comparatively higher friction value, can only be recognized if a difference of a steering moment to be adjusted on low friction value compared to a steering moment to be adjusted on comparatively higher friction value is sufficiently large. Therefore, the method according to the invention now does not determine a friction value characterizing a current friction between the vehicle wheel and the terrain, but the method according to the invention classifies the driving state, such that for example if and in particular exactly if it is required, a drive of the motor vehicle close to the limit range or near the limit range, hence a drive of the motor vehicle on such a terrain can be recognized, that an only low friction, hence an only low friction value, exists between the terrain and the vehicle wheel, which is for example lower than a level value. An advantage of the method according to the invention is in that the mentioned steering moment characteristic map, which has for example been determined for the high friction value, is sufficient to classify and thus determine the driving state. By classifying the driving state capable of being performed or performed within the scope of the method according to the invention, determining the in particular current driving state of the vehicle is to be understood since the driving state is qualitatively determined or evaluated by classifying the driving state.

In order to be able to particularly advantageously classify the driving state and thus to be able to realize a particularly advantageous operation of the vehicle, it is provided in an embodiment of the invention that at least one state value characterizing the driving state is determined by means of the electronic computing device depending on at least one measurement variable measured by means of the capturing device of the vehicle and influenced by the driving state, wherein the driving state is also associated with the one class depending on the state parameter for classifying the driving state.

For realizing a particularly advantageous operation, it therein has proven to be particularly advantageous if for classifying the driving state, if the state parameter has a first value and the difference is less than a preset threshold value, in particular at the same time, the driving state is associated with the one class. The one class is also referred to as first class or is a first one of the classes. For classifying the driving state, if the state parameter has the first value and, in particular at the same time, the difference is greater than or equal to the preset threshold value, the driving state is associated with the second one of the classes different from the first class. For classifying the driving state, if the state parameter has a second value different from the first value, the driving state is associated with a third one of the classes different from the first class and from the second class independently of the difference, that is independently of whether the difference is less than, greater than or equal to the preset threshold value, by means of the electronic computing device. Thus, if the state parameter has the first value, thus, this means that it can be sufficiently accurately differentiated between the first class and the second class, namely depending on the difference. However, if the state parameter has the second value, thus, a differentiation between the first class and the second class for example is not possible, such that then for example it cannot be sufficiently accurately determined if the current driving state of the vehicle corresponds to a safe drive of the vehicle or a drive of the vehicle close to the limit range. Hereby, misinformation of the rider can be advantageously avoided such that a particularly advantageous operation of the vehicle can be represented.

A further embodiment is characterized in that the measurement variable includes or characterizes the driving speed. Alternatively or additionally, the measurement variable includes or characterizes the roll angle also referred to as inclination position. Alternatively or additionally, the measurement variable is or includes a time derivative of the roll angle, wherein the time derivative of the roll angle is also referred to as roll rate. Alternatively or additionally, the measurement variable is or includes an acceleration of the vehicle also referred to as longitudinal acceleration, extending in vehicle longitudinal direction of the vehicle. Alternatively or additionally, the measurement variable is or includes an acceleration of the vehicle also referred to as transverse acceleration, extending in vehicle transverse direction of the vehicle. Hereby, it can be particularly advantageously decided if the current driving state is suitable or not to classify the driving state. Thus, the measurement variable, is, includes or characterizes at least one driving dynamics signal, hence in particular current driving dynamics of the vehicle.

In order to be able to particularly advantageously classify the state and thus to be able to realize a particularly advantageous operation of the vehicle, it is provided in further configuration of the invention that the actual torque value is determined by means of the electronic computing device, in that at least one first initial value is determined by means of the electronic computing device, which characterizes at least one dynamic steering moment portion acting in the steering also referred to as steering system and a stationary steering moment portion acting in the steering. Thus, the first initial value for example is or describes a sum of the at least one dynamic steering moment portion acting in the steering and the stationary steering moment portion acting in the steering. In particular, the at least one first initial value describes or characterizes the stationary steering moment portion and multiple, in particular all, dynamic steering moment portions acting in the steering, in particular such that the stationary steering moment portion and the at least one, dynamic steering moment portion, in particular the, most particularly all, dynamic steering moment portions, in total result in the first initial value. In addition, the actual torque value is therein preferably determined by means of the electronic computing device in that at least one second initial value is determined by means of the electronic computing device, which characterizes exclusively the at least one dynamic steering moment portion acting in the steering related to the at least one dynamic steering moment portion acting in the steering and the stationary steering moment portion acting in the steering. In order to determine the actual torque value, the actual torque value is determined depending on the initial values by means of the electronic computing device, in particular in that the second initial value is subtracted from the first initial value.

In order to be able to particularly advantageously determine the actual torque value and thus consequently the variable from the initial values, it is provided in further configuration of the invention that the second initial value is calculated by means of the electronic computing device depending on a rotational speed of the vehicle wheel and/or a further vehicle wheel of the vehicle and/or depending on a roll rate of the vehicle and/or depending on a roll acceleration of the vehicle and/or depending on a yaw acceleration of the vehicle and/or depending on a steering angle rate of the vehicle and/or depending on a deceleration, hence negative acceleration of the vehicle, in particular acting in vehicle longitudinal direction of the vehicle, and/or depending on a pressure in at least one wheel brake of the vehicle and/or depending on a gyroscopic moment of the vehicle also referred to as gyroscopic torque. For example, the rotational speed of the vehicle is captured by means of a rotational speed sensor. The roll rate of the vehicle is the first time derivative of the roll angle, and the roll acceleration of the vehicle is the second time derivative of the roll angle, hence the first time derivative of the roll rate. The yaw acceleration is the first derivative of a yaw angle of the vehicle in particular acting about the vehicle vertical direction of the vehicle. The deceleration of the vehicle results for example from braking the vehicle. The wheel brake is for example associated with the vehicle wheel and formed to brake the vehicle wheel and thus the vehicle. Thus, the wheel brake for example formed as a friction brake is a service brake of the vehicle.

In order to be able to particularly advantageously determine the actual torque value, it is provided in further configuration of the invention that a torque acting in the steering is captured as the steering moment by means of a capturing device of the vehicle, wherein the actual torque value is determined depending on the captured torque. For example, the capturing device is or includes the measurement device or the capturing device is a part of the measurement device. For example, the first initial value is determined, in particular measured, depending on the capture of the steering moment. Hereto, the capturing device for example provides an in particular electrical moment signal, which characterizes the measured steering moment and therein for example the first initial value. The electronic computing device can receive the moment signal and thereby determine the first initial value. Thus, the steering moment for example includes the dynamic steering moment portion and the at least one stationary steering moment portion. Further, it is conceivable that the electronic computing device receives the moment signal and determines the first initial value from the or depending on the moment signal. For example, the moment signal is the measurement device signal or a part of the measurement device signal or a further signal.

The actual torque value is determined depending on the initial values for example such that the second initial value is subtracted from the first initial value.

In order to be able to particularly advantageously determine the actual torque value, it is provided in further configuration of the invention that at least one influence value, which characterizes an influence of a relative position between the vehicle and the person, in particular currently, using the vehicle on the steering moment currently acting in the steering of the vehicle, is determined by means of the electronic computing device, in that at least one position value is determined by means of the electronic computing device, which characterizes a captured variable captured by means of a sensor device, in particular of the vehicle, and influenced by the relative position between the person using the vehicle and the vehicle. Depending on the position value, the influence value is determined, wherein the actual torque value is determined depending on the influence value. The relative position is a position, which the person in particular currently using the vehicle, in particular currently, takes in relation to the vehicle, wherein the relative position is also referred to as seating position or rider seating position. The background of this embodiment is in that the relative position also referred to as seating position or rider seating position between the person using the vehicle and the vehicle can have an influence on the steering moment in total, in particular if the seating position deviates from an initial position also referred to as neutral position. This is in particular the case if the torso of the person for example sitting in or on a seat assembly of the vehicle deviates from the vehicle vertical direction also referred to as vehicle vertical axis or vertical axis in vehicle transverse direction of the vehicle and thus viewed in a plane also referred to as y-z plane, which is spanned by the vehicle transverse direction and by the vehicle vertical direction, such that the torso is inclined in vehicle transverse direction with respect to the vertical axis for example extending through the center of gravity of the vehicle also referred to as center of mass. Further, the seating position can for example influence the steering moment if or in that an in particular current seating point, in which the person, in particular with their buttocks, is sitting on or in the seat assembly, is offset to the center of gravity of the vehicle and thus offset to the vertical axis viewed in vehicle transverse direction and thus for example in the mentioned plane, hence has an offset extending in vehicle transverse direction and in particular in the plane to the center of gravity of the vehicle or to the vertical axis of the vehicle. By measuring, that is capturing the measurement variable and thus the relative position, a possible influence, hence a possible effect of the relative position on the steering moment can be determined and advantageously considered in determining the actual torque value such that the current driving state of the vehicle can be particularly advantageously classified and an advantageous operation of the vehicle can be realized as a consequence.

However, the method according to the invention does not necessarily comprise the capture of the captured variable by means of the sensor device.

However, it has proven to be particular if the captured variable is captured by means of the sensor device in the method, whereby the relative position can be particularly advantageously considered.

In order to be able to particularly advantageously determine the relative position, it is provided in a further embodiment of the invention that a sensor device of the vehicle is used as at least a part of the sensor device.

A further embodiment is characterized in that a sensor device arranged at the person is used as at least a part of the sensor device, whereby the measurement variable and thus the relative position can be particularly advantageously measured, that is captured.

In a further, particularly advantageous embodiment of the invention, it is provided that a sensor device arranged on at least one piece of clothing of the person is used as at least a part of the sensor device, whereby the relative position and thus the measurement variable can be particularly advantageously captured in particular in a manner particularly comfortable for the person.

Finally, it has proven to be particularly advantageous if the vehicle is a single-track two-wheeled vehicle, in particular formed as a motorbike.

A second aspect of the invention relates to a vehicle, which is formed for performing a method according to the first aspect of the invention. Advantages and advantageous configurations of the first aspect of the invention are to be regarded as advantages and advantageous configurations of the second aspect of the invention and vice versa.

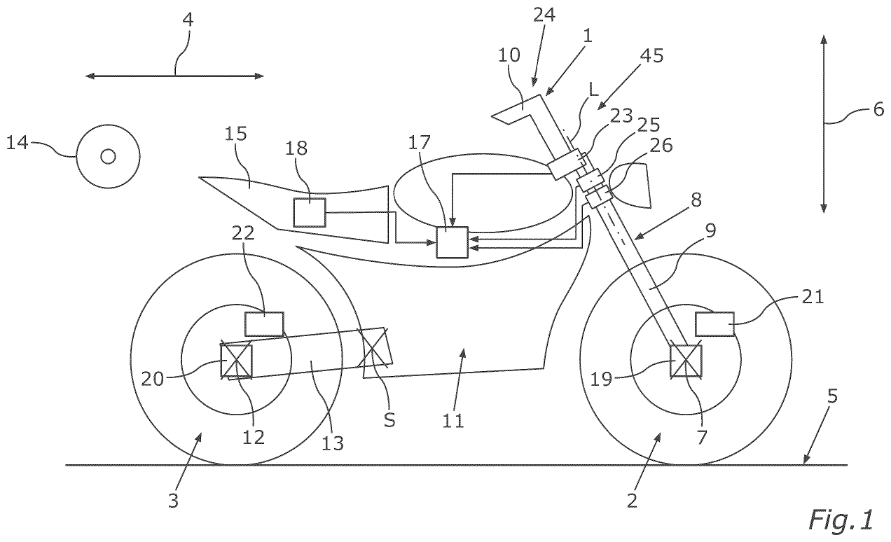

FIG. 1 shows a vehicle 1 presently formed as a single-track two-wheeled vehicle in a schematic side view, which is formed as a single-track motorcycle, in particular as a single-track motorbike, in the embodiment shown in FIG. 1. The vehicle 1 comprises exactly two vehicle wheels 2 and 3, which are arranged together and thus in succession in vehicle longitudinal direction of the vehicle 1. The vehicle longitudinal direction is illustrated by a double arrow 4. In the embodiment shown in FIG. 1, the vehicle wheel 2 is a front wheel and the vehicle wheel 3 is a rear wheel. The vehicle wheels 2 and 3 are simply also referred to as wheels. The vehicle wheels 2 and 3 are ground contact elements of the vehicle 1, which is or can be downwardly supported on a ground 5 also referred to as terrain in vehicle vertical direction of the vehicle 1 via the ground contact elements. If the vehicle 1 is driven long the ground 5, while the vehicle 1 is downwardly supported on the ground 5 in vehicle vertical direction of the vehicle 1 via the ground contact elements, thus, the ground contact elements, in particular directly, roll on the ground 5. The vehicle vertical direction of the vehicle 1 is illustrated by a double arrow 6. The vehicle wheel 2 is rotatably retained on a steering element 8 about a wheel rotational axis 7 in relation to the steering element 8 of the vehicle 1. The steering element 8 includes a steering fork 9 and a handle 10 and is pivotably retained on a chassis 11 about a pivot axis also referred to as steering axis L in relation to the chassis 11 of the vehicle 1 presently formed as a frame. For example, the handle 10 is a handlebar or formed by a handlebar. The steering element 8 and with it the vehicle wheel 2 are pivotable and thus capable of being steered about the steering axis L in relation to the chassis 11. A person in particular currently using the vehicle 1 can grip, in particular encompass, the handle 10 with their hands, whereby the person in particular currently using the vehicle 1 can exert a force or a torque on the steering element 8 in particular via the handle 10 via their arms, which include the hands of the person. The steering element 8 and thus the handle 10 are constituents of a steering 24 of the vehicle 1 also referred to as steering system, such that the person can exert the above mentioned torque or the above mentioned force on the steering 24. A torque also referred to as person moment or person torque in particular acting in the steering 24 and in particular about the steering axis L results from it. By pivoting the steering element 8, that is the steering 24, and thus the vehicle wheel 2 effected about the steering axis L and in relation to the chassis 11, cornering maneuvers, driving direction changes and roadway or lane changes of the vehicle 1 can be effected. The vehicle wheel 3 is rotatably retained on a swingarm 13 about a second wheel rotational axis 12 in relation to the swingarm 13 of the vehicle 1 also referred to as rear wheel swingarm. The swingarm 13 is in turn pivotably retained on the chassis 11 about a pivot axis S in relation to the chassis 11 such that the swingarm 13 and the vehicle wheel 3 are pivotably retained on the chassis 11 about the pivot axis S in relation to the chassis 11. Upon straight drive of the vehicle 1, which in particular drives forward and therein in particular along a straight line in vehicle longitudinal direction upon its straight drive, the wheel rotational axes 7 and 12 extend parallel to each other. In addition, the pivot axis S additionally extends in vehicle transverse direction of the vehicle 1, the vehicle transverse direction of which is illustrated by a double arrow 14 and extends perpendicularly to the image plane of FIG. 1. For example, the vehicle 1 comprises a seat 15 for example retained on the chassis 11, which is also referred to as seat assembly. The person currently using the vehicle 1 for example is sitting on the seat 15, in particular in a seating point, wherein the person is for example a rider of the vehicle 1. The person can sit on the seat 15 and consequently grip, in particular encompass, the handle 10 with their hands, such that the person can pivot the steering element 8 and thus the steering 24 and thereby the vehicle wheel 2 about the steering axis L in relation to the chassis 11 with their hands via the handle 10. Hereby, the person can effect cornering maneuvers, driving direction changes and lane changes of the vehicle 1, hence steer the vehicle 1. Again put in other words, the steering element 8 and with it the vehicle wheel 2 are pivotable about the steering axis L in relation to the chassis 11 for steering the vehicle 1.

The vehicle 1 also comprises an electronic computing device 17 also referred to as control device, by means of which, as will be explained in more detail in the following, a method for classifying an in particular current driving state of the vehicle 1 is performed. In the method, the vehicle 1 is for example driven along the ground 5, while the vehicle 1 is downwardly supported on the ground 5 in vehicle vertical direction via the ground contact elements, and thus the ground contact elements, in particular directly, roll on the ground 5.

The vehicle 1 comprises a sensor device 45, which for example includes inertial measurement technology 18. By means of the inertial measurement technology 18, accelerations of the vehicle 1 and therein for example accelerations of the vehicle 1 extending in vehicle transverse direction and/or in vehicle longitudinal direction and/or in vehicle vertical direction can for example be captured. Further, a roll angle of the vehicle 1 can for example be captured by means of the inertial measurement technology 18. Further, it is conceivable that a roll rate as a first time derivative of the roll angle and/or a roll acceleration as a second time derivative of the roll angle, hence as a first time derivative of the roll rate, and/or a yaw acceleration of the vehicle 1 can be captured by means of the inertial measurement technology 18. The sensor device 45 includes a wheel rotational speed sensor 19 associated with the vehicle wheel 2, simply also referred to as rotational speed sensor, by means of which a rotational speed of the vehicle wheel 2 about the wheel rotational axis 7 can be captured. Furthermore, the sensor device 45 comprises a wheel rotational speed sensor 20 simply also referred to as rotational speed sensor, associated with the vehicle wheel 3, by means of which a rotational speed of the vehicle wheel 3 about the wheel rotational axis 12 can be captured. For example, a respective wheel brake is associated with the respective vehicle wheel 2, 3. The respective wheel brake can be a friction brake. In particular, the respective wheel brake can be formed as a respective disk brake. Most preferably, the respective wheel brake is a service brake of the vehicle 1, which can be braked by means of the respective service brake. Therein, the sensor device 45 for example comprises a brake pressure sensor 21, which is associated with the wheel brake associated with the vehicle wheel 2. The wheel brake associated with the vehicle wheel 2 is also referred to as first wheel brake, wherein a first brake pressure simply also referred to as first pressure in the first wheel brake can be captured by means of the brake pressure sensor 21. The sensor device 45 additionally includes a second brake pressure sensor 22, which is associated with the wheel brake associated with the vehicle wheel 3, also referred to as second wheel brake. By means of the brake pressure sensor 22, a second brake pressure simply also referred to as second pressure in the second wheel brake can be captured. Furthermore, the sensor device 45 for example includes a steering moment sensor 23, by means of which a steering moment acting about the steering axis L and in the steering 24 can be captured. In other words, the mentioned steering moment is a torque acting in the steering 24, which can for example be captured by means of the steering moment sensor 23 of the sensor device 45. Therein, the steering moment for example results exclusively or at least partially from the previously mentioned person moment. In other words, the steering moment can for example correspond to the person moment, hence be the person moment, or the steering moment is composed of the person moment and at least or exactly one further torque. Optionally, the sensor device 45 includes a steering angle sensor 25, by means of which a respective steering angle extending about the steering axis L can be captured, by which the steering element 8 can be pivoted about the steering axis L in relation to the chassis 11.

For effecting the straight drive of the vehicle 1, the steering element 8 is in a straight-ahead position, in which the steering angle is 0 degrees. Optionally, the sensor device 45 includes a steering rate sensor 26, by means of which a steering rate of the steering element 8 or the steering 24 can be captured. In particular, the steering rate is the first time derivative of the steering angle.

In particular, the method is performed during a drive of the vehicle 1, which is driven along the ground 5 during the drive, while the vehicle 1 is downwardly supported on the ground 5 in vehicle vertical direction via its ground contact elements. In particular, the drive is cornering, in which the vehicle 1 for example drives, in particular forward, through a curve such as for example a right-hand curve or a left-hand curve, such that the vehicle 1 is for example in inclination position in the drive and in performing the method and thus has a non-zero roll angle.

The roll angle of the vehicle 1 can for example be captured by means of the sensor device 45, in particular by means of the inertial measurement technology 18.

For example, a measurement variable referred to as captured variable is captured and thus measured by means of the sensor device 45, which is influenced by a relative position also referred to as seating position or rider seating position between the vehicle 1 and the person currently using the vehicle 1 and currently sitting on the seat 15 in particular in the seating point. This means that the captured variable characterizes, that is describes or includes the relative position. By means of the electronic computing device 17, a position value is for example determined, which characterizes the measured captured variable that is captured. The relative position can have an influence on the steering moment in particular currently acting in the steering 24, wherein an influence value is determined by means of the electronic computing device 17 depending on the position value such that the influence value characterizes the measurement variable and thus the relative position and thus an influence, hence an effect of the relative position on the steering moment currently acting in the steering 24.

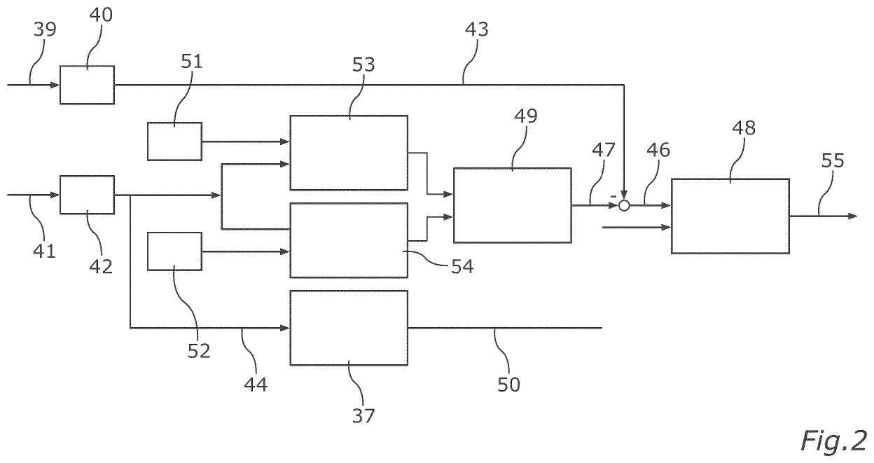

In the method, the steering moment is measured for example by means of the sensor device 45, in particular by means of the steering moment sensor 23. Therein, the sensor device 45, in particular the steering moment sensor 23, for example provides an in particular electrical measurement signal, which characterizes, that is indicates or describes the steering moment measured by means of the sensor device 45. In FIG. 2, an arrow 39 illustrates the steering moment measured by means of the sensor device 45. Thus, the arrow 39 for example illustrates the measurement signal characterizing the measured steering moment. For example, the measurement signal 39 is filtered by means of a filter 40. The filtered measurement signal is or includes a measurement value or is also referred to as measurement value, wherein the measurement value is used as a first initial value. The previously mentioned measurement signal is also referred to as first measurement signal. Moreover, the sensor device 45 is or includes a capturing device, by means of which driving dynamics variables are measured, which describe the in particular current driving state, that is current driving dynamics of the vehicle 1. Therein, the capturing device, that is the sensor device 45, for example provides a second measurement signal, which is for example filtered by means of a second filter 42. In FIG. 2, an arrow 41 illustrates the driving dynamics variables. Thus, the arrow 41 for example illustrates the second measurement signal. The second measurement signal is also referred to as driving dynamics signal. The driving dynamics variables for example include a rotational speed of the vehicle wheel 2, a rotational speed of the vehicle wheel 3, the roll angle of the vehicle 1, a roll rate of the vehicle 1 as the first time derivative of the roll angle, a roll acceleration of the vehicle 1 as the second time derivative of the roll angle, a yaw acceleration of the vehicle 1, the steering angle rate, a positive and/or negative acceleration of the vehicle 1 in particular acting in vehicle longitudinal direction of the vehicle 1, the pressure in the first wheel brake, the pressure in the second wheel brake and/or an acceleration of the vehicle 1 acting in vehicle vertical direction of the vehicle 1 and/or other parameters. Thus, the capturing device is at least one measurement variable, which is influenced by the in particular current driving state and includes, indicates, characterizes or describes the mentioned driving dynamics variables, which are influenced by the in particular current driving state. Therein, at least one state value characterizing the current driving state of the vehicle 1 is for example determined by means of the electronic computing device 17 depending on at least one of the driving dynamic variables, in particular depending on the driving dynamics variables, and thus depending on the measurement variable.

In FIG. 2, an arrow 43 illustrates the above mentioned first initial value, which characterizes the steering moment in particular filtered by means of the filter 40, captured by means of the steering moment sensor 23. Alternatively or additionally, a further one of the driving dynamics variables can for example be a current driving speed of the vehicle 1, which is driven, in particular forward, with the current driving speed along the ground 5, while the vehicle 1 is downwardly supported on the ground 5 in vehicle vertical direction via the ground contact elements. An arrow 44 illustrates an actual angle value, which characterizes the current roll angle of the vehicle 1, measured by means of the sensor device 45, in particular by means of the inertial measurement technology 18, and for example filtered by means of the filter 40. In addition, the arrow 44 illustrates an actual speed value, which characterizes the current driving speed of the vehicle 1 measured by means of the sensor device 45, in particular by means of the inertial measurement technology 18, and in particular filtered by means of the filter 40. In FIG. 2, a reference characteristic map is illustrated by 37, which is for example stored in an in particular electrical or electronic data memory of the electronic computing device 17. The actual speed value characterizing the current driving speed of the vehicle 1 captured and thus measured by means of the sensor device 45 and the actual value characterizing the current roll angle of the vehicle 1 measured and thus captured by means of the sensor device 45 form an actual pair of values. For example, the reference characteristic map 37 was determined for a reference friction value, which is for example 1.0 and characterizes a friction between the vehicle wheel 2 and the terrain (ground 5) or another terrain. The reference characteristic map 37 includes multiple reference angle values, multiple reference speed values and multiple reference torque values, wherein the reference characteristic map 37 associates exactly one of the reference torque values with a respective reference pair of values, which includes exactly one of the reference angle values and exactly one of the reference speed values. Depending on the actual pair of values, one of the reference pairs of values is selected from the reference characteristic map 37 as the pair of values associated with the actual pair of values. The reference torque value associated with the selected reference pair of values by the reference characteristic map 37 is determined by means of the electronic computing device 17, hence read out of the reference characteristic map 37. In FIG. 2, an actual torque value also referred to as stationary value Mstationär is illustrated by an arrow 46, which is determined, in particular calculated, from the first initial value illustrated by the arrow 43 and from a second initial value illustrated by an arrow 47 by means of the electronic computing device 17, in particular such that or in that a difference between the first initial value and the second initial value is formed. The determined reference torque value is illustrated in FIG. 2 by an arrow 50.

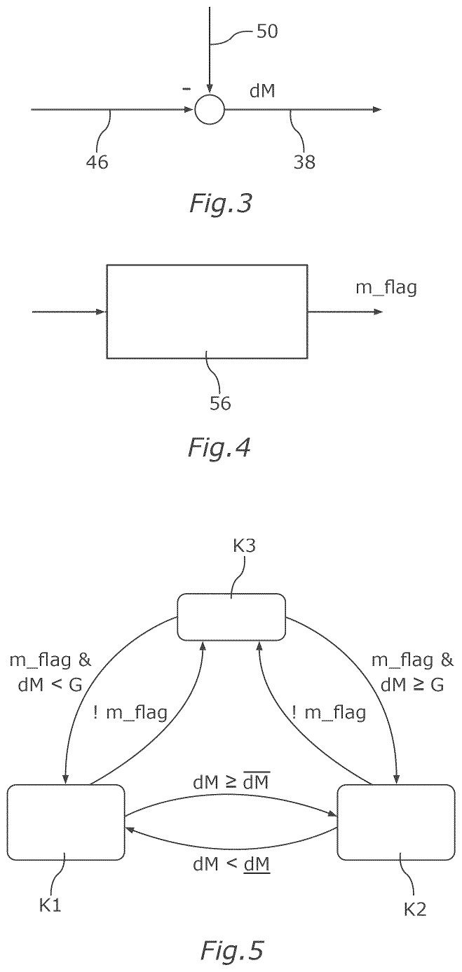

In FIG. 2, it is illustrated by a block 48 that a comparison is performed by means of the electronic computing device 17, in which the determined reference torque value illustrated by the arrow 50 is compared to the determined actual torque value illustrated by the arrow 46. In the comparison, the determined reference torque value is compared to the determined actual torque value by means of the electronic computing device 17, wherein in the or by the comparison, a difference denoted by dM in FIG. 3 between the determined reference torque value and the determined actual torque value is determined by means of the electronic computing device 17. The difference dM is illustrated by an arrow 38 in FIG. 3. Thus, the difference dM is an output variable of the mentioned comparison illustrated by the arrow 38. Furthermore, the block 48 illustrates a classification of the in particular current driving state of the vehicle 1, wherein the classification is performed by means of the electronic computing device 17.

FIG. 5 illustrates classes K1, K2 and K3, which are different from each other in pairs. For example, the classes K1, K2 and K3 are stored in a, in particular electrical and/or electronic, data memory of the electronic computing device 17. In the classification of the in particular current driving state of the vehicle 1 illustrated by the block 48 in FIG. 2, for classifying the in particular current driving state of the vehicle 1, in particular exactly, one of the multiple preset classes K1, K2 and K3 is associated by means of the electronic computing device 17 depending on the difference dM. This means that the driving state of the vehicle 1 is categorized into, in particular exactly, one of the preset classes K1, K2 and K3 in the classification by means of the electronic computing device 17 depending on the difference dM. This categorization of the driving state into the, in particular exactly, one of the preset classes K1, K2 and K3 is the previously mentioned classification illustrated by the block 48.

In FIG. 2, an arrow 55 illustrates an output variable of the classification illustrated by the block 48, wherein this output variable is a result of the classification. The result of the classification is or includes for example at least or exactly one classification value, which characterizes the class K1, K2, K3, into which the driving state is or was categorized in the classification by means of the electronic computing device 17. Thus, FIG. 5 for example illustrates a content of the block 48, hence a content of the classification. In other words, FIG. 5 for example illustrates one or more procedures, which are performed in the classification for classifying the driving state.

The steering moment acting in the steering 24, which is for example measured, that is captured, by means of the steering moment sensor 23, is for example composed of at least or exactly one stationary steering moment portion and at least one or more, dynamic steering moment portions. The actual torque value also referred to as stationary value Mstationär for example characterizes exclusively the stationary steering moment portion related to the stationary steering moment portion and related to the at least one dynamic steering moment portion, wherein the second initial value illustrated by the arrow 47 for example characterizes the at least one dynamic steering moment portion, in particular the dynamic steering moment portions, wherein the second initial value is for example subtracted, that is deducted, from the first initial value.

In FIG. 2, a block 51 illustrates parameters of the vehicle 1 also referred to as vehicle parameters, wherein the vehicle parameters for example characterize the vehicle 1 and/or the in particular current driving state of the vehicle 1. In addition, correction factors are illustrated by a block 52. By a block 53, it is illustrated that the dynamic steering moment portions are calculated by means of the electronic computing device 17 depending on at least a part of the driving dynamics variables measured by means of the sensor device 45 and for example filtered by means of the filter 42. In addition, it is illustrated by a block 54 that correction terms are calculated, in particular as correction torques, depending on the correction factors and depending on at least a part of the driving dynamics variables measured by means of the sensor device 45 and for example filtered by means of the filter 42. For example, the correction terms are denoted by Mkorr, and the dynamic steering moment portions are for example denoted by Mdyn, wherein the correction terms and the dynamic steering moment portions are for example combined to the second initial value at a block 49, in particular by addition. This means that the second initial value for example includes the dynamic steering moment portions and the correction terms. In particular, the correction terms and the dynamic steering moment portions are combined to the second initial value, for example by addition. The second initial value is for example subtracted from the first initial value, hence from the measurement value, to thereby eliminate the correction terms and the dynamic steering moment portions from the measurement value (first initial value). Thus, the actual torque value illustrated by the arrow 46 for example particularly advantageously characterizes the stationary steering moment portion of the steering moment measured by means of the sensor device 45, actually and currently acting in the steering 24.

For example, at least one component of the vehicle 1 is operated depending on the classification, in particular depending on the classification value. For example, the component is or includes a driver assistance system of the vehicle 1. Alternatively or additionally, the component for example is or includes an in particular electrical or electronic playback device of the vehicle 1. By means of the playback device, an indication signal optically and/or haptically and/or acoustically perceivable by the person currently using the vehicle 1 is for example output into or to an environment of the playback device. Hereby, the person currently using the vehicle 1 can be informed about the classification or about the class, into which the driving state has been categorized. As a result, the person can for example adapt their driving behavior to be able to safely drive the vehicle 1.

In FIG. 4, a block 56 illustrates an examination of a suitability of the current driving state of the vehicle 1 for the classification. This examination is performed by means of the electronic computing device 17. In the examination, the electronic computing device 17 examines if the current driving state of the vehicle 1 also referred to as maneuver or driving maneuver is suitable to be classified, hence to perform the classification or in which manner the classification is performed. In this respect, it is illustrated by the block 56 that at least one state value characterizing the driving state, which is denoted by m_flag in FIG. 4, is determined by means of the electronic computing device 17 depending on at least one measurement variable measured by means of the sensor device 45 of the vehicle 1 and influenced by the current driving state of the vehicle 1. Hereto, the sensor device 45 for example is or includes a capturing device, by means of which the mentioned measurement variable is measured, that is captured. Therein, the second measurement signal, hence the driving dynamics signal, for example is, includes or characterizes, hence describes, the measurement variable. For example, the measurement variable is or includes the in particular current speed of the vehicle 1 and/or the roll angle and/or the roll rate and/or a longitudinal acceleration of the vehicle 1 and/or a vertical acceleration of the vehicle 1, the vertical acceleration of which extends in vehicle vertical direction. For classifying the driving state of the vehicle 1, the driving state is also categorized into the one class K1, K2 and K3 depending on the state parameter m_flag.

FIG. 5 illustrates a state machine, by means of which the classification is performed depending on the difference dM and depending on the state value. The class K1 is or characterizes an in particular current, safe drive of the vehicle 1. Thus, if the current driving state is categorized into the class K1, thus, the current driving state is classified as a safe drive, that is as a safe driving state. The class K2 is or characterizes a drive of the vehicle 1 close to a limit range of the vehicle 1, hence for example a drive of the vehicle 1 on a terrain with a reduced friction value between the terrain and the respective vehicle wheel 2, 3. By the reduced friction value, a friction value is to be understood, which is lower than a for example preset or presettable limit value. Thus, if the current driving state of the vehicle 1 is categorized into the class K2, thus, the current driving state of the vehicle 1 is thereby classified as a drive close to the limit range, hence a drive on the terrain with the reduced friction value. The class K3 is or characterizes an unknown, in particular current, driving state of the vehicle 1. Thus, if the current driving state of the vehicle 1 is for example categorized into the class K3, thus, it is estimated or determined thereby that a statement, a determination or an inference about the current driving state of the vehicle 1 cannot be made to the effect if the current drive, hence the current driving state of the vehicle 1, is a safe drive or a drive close to the limit range.

For example, the state value can take, in particular exactly, two values different from each other, namely a first value and a second value. For example, the first value is one. For example, the second value is zero. Thus, the state value can for example either be “true”, which for example corresponds to the value one, or the state value can be “false”, which for example corresponds to the value zero. In the classification, for example if and in particular always if the state parameter has the first value and the difference dM is less than a preset threshold value G, the driving state of the vehicle 1 is associated with the class K1, hence categorized into the class K1. In the classification, if and in particular always if the state parameter has the first value and the difference dM is greater than or equal to the preset threshold value G, the driving state is associated with the second class K2 different from the first class K1 and from the third class K3, hence categorized into the class K2. In the classification, if and in particular always if the state parameter has the second value, the driving state is associated with the third class K3, hence categorized into the third class K3, independently of the difference dM. By the feature that if and in particular always if the state parameter has the second value, the driving state is categorized into the third class K3 independently of the difference dM, it is to be understood that if the state parameter has, it is insignificant if the difference dM is less than the threshold value G, greater than the threshold value G or equal to the threshold value G, the driving state is always, that is independently of whether the difference dM is greater than, less than or equal to the threshold value G, categorized into the third class K3. The background is as follows: If it is determined that the state value has the second value, thus, it is determined hereby that a statement, determination or estimation cannot be made to the effect if the current driving state is a safe drive or a drive close to the limit range. Thereby, misinformation of the person currently using the vehicle 1 can be avoided.

### LIST OF REFERENCE CHARACTERS

1 Vehicle
2 vehicle wheel
3 vehicle wheel
4 double arrow
5 ground
6 double arrow
7 wheel rotational axis
8 steering element
9 steering fork
10 handle
11 chassis
12 wheel rotational axis
13 swingarm
14 double arrow
15 seat
17 electronic computing device
18 inertial measurement technology
19 wheel rotational speed sensor
20 wheel rotational speed sensor
21 brake pressure sensor
22 brake pressure sensor
23 steering moment sensor
24 steering
25 steering angle sensor
26 steering rate sensor
37 reference characteristic map
38 arrow
39 arrow
40 block
41 arrow
42 block
43 arrow
44 arrow
45 sensor device
46 arrow
47 arrow
48 block
49 block
50 arrow
51 block
51 block
52 block
53 block
54 block
55 arrow
56 block
dM difference
L steering axis
m_flag state value
G threshold value

1. A method for classifying a driving state of a vehicle, in which by means of an electronic computing device:
at least one actual torque value is determined, which characterizes a current steering moment acting in a steering of the vehicle;
at least one actual angle value is determined, which characterizes a current roll angle of the vehicle;
at least one actual speed value is determined, which characterizes a current driving speed of the vehicle and forms an actual pair of values with the associated actual angle value;
depending on the actual pair of values, one of the reference pairs of values is selected as the pair of values associated with the actual pair of values from a reference characteristic map, which includes multiple reference angle values, multiple reference speed values and multiple reference torque values and associates exactly one of the reference torque values with a respective reference pair of values, which includes exactly one of the reference angle values and exactly one of the reference speed values;
the reference torque value associated with the selected reference pair of values is determined;
the determined reference torque value is compared to the determined actual torque value, whereby a difference between the determined reference torque value and the determined actual torque value is determined; and
for classifying the driving state, the driving state is associated with one of multiple preset classes depending on the difference.

2. The method according to claim 1:
wherein at least one state value (m_flag) characterizing the driving state is determined by means of the electronic computing device depending on at least one measurement variable measured by means of a capturing device of the vehicle and influenced by the driving state, wherein the driving state is also associated with the one class depending on the state parameter (m_flag) for classifying the driving state.

3. The method according to claim 2:
wherein for classifying the driving state, if the state parameter (m_flag) has a first value and the difference is less than a preset threshold value, the driving state is associated with the one class as the first class;
wherein for classifying the driving state, if the state parameter (m_flag) has the first value and the difference is greater than or equal to the preset threshold value, the driving state is associated with a second one of the classes different from the first class; and
wherein for classifying the driving state, if the state parameter (m_flag) has a second value different from the first value, the driving state is associated with a third one of the classes different from the first class and from the second class independently of the difference.

4. The method according to claim 2, wherein:
the measurement variable:
includes or characterizes the driving speed; and/or
includes or characterizes the roll angle; and/or
includes or characterizes a time derivative of the roll angle; and/or
includes or characterizes an acceleration of the vehicle extending in vehicle longitudinal direction of the vehicle; and/or
includes or characterizes an acceleration of the vehicle extending in vehicle transverse direction of the vehicle.

5. The method according to claim 1:
wherein the actual torque value is determined by means of the electronic computing device in that by means of the electronic computing device:
wherein at least one first initial value is determined, which characterizes at least one dynamic steering moment portion acting in the steering and a stationary steering moment portion acting in the steering;
wherein at least one second initial value is determined, which exclusively characterizes the at least one dynamic steering moment portion acting in the steering related to the at least one dynamic steering moment portion acting in the steering and the stationary steering moment portion acting in the steering; and
the actual torque value is determined depending on the initial values.

6. The method according to claim 5, wherein:
the second initial value is calculated by means of the electronic computing device depending on:
a rotational speed of the vehicle wheel and/or at least one further vehicle wheel of the vehicle; and/or
a roll rate of the vehicle; and/or
a roll acceleration of the vehicle; and/or
a yaw acceleration of the vehicle; and/or
a steering angle rate of the vehicle; and/or
a deceleration of the vehicle; and/or
a pressure in at least one wheel brake of the vehicle and/or
a gyroscopic moment of the vehicle.

7. The method according to claim 1:
wherein a torque acting in the steering is captured as the steering moment by means of a capturing device of the vehicle, wherein the actual torque value is determined depending on the captured torque.

8. The device according to claim 7:
wherein the first initial value is determined depending on the torque captured by means of the sensor device.

9. The method according to claim 1:
wherein at least one influence value, which characterizes an influence of a relative position between the vehicle and a person using the vehicle on the steering moment currently acting in the steering of the vehicle is determined by means of the electronic computing device in that by means of the electronic computing device:
wherein at least one position value is determined, which characterizes a captured variable captured by means of a sensor device and influenced by the relative position between the person using the vehicle and the vehicle; and
wherein the influence value is determined depending on the position value, wherein the actual torque value is determined depending on the influence value.

10. The method according to claim 9:
wherein the captured variable is captured by means of the sensor device.

11. The method according to claim 10:
wherein a sensor device of the vehicle is used as at least a part of the sensor device.

12. The method according to claim 10:
wherein a sensor device arranged at the person is used as at least a part of the sensor device.

13. The method according to claim 1:
wherein a sensor device arranged on at least one piece of clothing of the person is used as at least a part of the sensor device.

14. The method according to claim 1:
wherein the vehicle is formed as a single-track two-wheeled vehicle.

15. A vehicle, which is formed for performing a method for classifying a driving state of a vehicle, in which by means of an electronic computing device:
at least one actual torque value is determined, which characterizes a current steering moment acting in a steering of the vehicle;
at least one actual angle value is determined, which characterizes a current roll angle of the vehicle;
at least one actual speed value is determined, which characterizes a current driving speed of the vehicle and forms an actual pair of values with the associated actual angle value;
depending on the actual pair of values, one of the reference pairs of values is selected as the pair of values associated with the actual pair of values from a reference characteristic map, which includes multiple reference angle values, multiple reference speed values and multiple reference torque values and associates exactly one of the reference torque values with a respective reference pair of values, which includes exactly one of the reference angle values and exactly one of the reference speed values;
the reference torque value associated with the selected reference pair of values is determined;
the determined reference torque value is compared to the determined actual torque value, whereby a difference between the determined reference torque value and the determined actual torque value is determined; and
for classifying the driving state, the driving state is associated with one of multiple preset classes depending on the difference.
